(19) United States
(12) Patent Application Publication
(10) Pub. No.: US 2003/0056710 A1
(43) Pub. Date: Mar. 27, 2003

(54) Moisture indicator

(76) Inventors: Edmund Radmacher, Duren (DE); Jurgen Hoffman, Duren (DE); Klaus Moller, Eschweller (DE)

Correspondence Address: Joseph W. Berenato, III, Liniak, Berenato & White, LLC, 6550 Rock Spring Drive, Ste. 240, Bethesda, MD, 20817, US

(21) Appl. No.: 10/233,479

(22) Filed: Sep. 4, 2002

(30) Foreign Application Priority Data
Sep. 15, 2001 (DE) 201 15 189.8

(51) Int. Cl. G01D 21/00

(52) U.S. Cl. 116/206

(57) ABSTRACT

The moisture indicator has a support that is equipped with a substance which contains a moisture-indicating medium that reversibly changes color as a function of moisture. According to the present invention, the moisture-indicating medium is a pH indicator dye that is combined with a zinc salt.

The invention concerns a moisture indicator having a support that is equipped with a substance which contains a moisture-indicating medium that reversibly changes color as a function of moisture.

Moisture indicators of the present kind are used in many ways to determine relative humidity, for example in packaged products, so that the penetration of moisture during storage and transport can be ascertained. Moisture indicators of this kind are also known in the form of test papers and test cards. An absorbent paper, impregnated with a substance that contains a moisture-indicating medium, serves as the support. This moisture-indicating medium changes color reversibly as a function of the relative humidity. By evaluating the color or by comparing it to a color comparison surface held alongside, the relative humidity can be determined with a sensitivity limit of approximately +/−5%.

Cobalt(II) chloride has been widely used as a moisture-indicating medium (cf. U.S. Pat. No. 3,216,802; DE 40 32 025 C2). This moisture-indicating medium has a high potential for toxicity and is suspected of being carcinogenic (cf. WO 00/65339; WO 01/09601 A1).

The aforementioned documents therefore proposed moisture indicators in which a silica gel support impregnated on the one hand with iron(II) and/or iron(III) salts (WO 00/65339), or with copper chloride and one or more metal chlorides (WO 01/09601 A1), is used. These color indicators, however, have a color change that is not very distinctly detectable.

For adsorptive drying of neutral gases, it is known to bring the gas into contact with, in particular, particulate adsorption elements based on inorganic oxides (cf. U.S. Pat. No. 5,766,312; EP 0 648 532 A2). The adsorption elements are equipped with an organic indicator dye so that the relative humidity in the neutral gas during the drying operation can be indicated. Indicator dyes belonging to the group comprising phenolphthalein, cresol red, and thymol blue are recited. The adsorption elements are impregnated with this indicator dye in the form of a solution, and then dried. Here again, the color changes are not particularly distinct.

It is the object of the invention to configure a moisture indicator of the kind cited initially in such a way that it gives a particularly distinct indication as the humidity changes.

This object is achieved, according to the present invention, by the fact that the moisture-indicating medium is a pH indicator dye, preferably having a color change in the acid range, that is combined with a zinc salt. The basic idea of the invention is thus to use a combination of a pH indicator dye and a zinc salt. It has been found that particularly distinct color changes are thereby achievable, and that the relative humidity can therefore be determined in very easy and informative fashion by comparison with a color comparison scale.

In a development of the invention, provision is made for the indicator dye to belong to the group comprising m-cresol purple, thymol blue, Tropaeolin 100, or p-xylenol blue. These indicator dyes have proven successful in particular because of their spectral color change, and moreover are not harmful to health.

A number of variations are suitable as the zinc salt, for example zinc chloride, zinc nitrate, zinc sulfate, or zinc acetate, which are commercially obtainable in either anhydrous form or as their hydrates.

To ensure that the zinc salt makes the indicator dye optimally effective, the indicator dye and zinc salt should be present at a ratio by weight of at least 1:5, preferably 1:20, or even better 1:30. The color change varies depending on the nature and quantitative ratio of the zinc salt that is used.

The moisture indicator can be produced by dissolving 0.1 g indicator dye and a suitable quantity of zinc salt ranging from 1.15 to 3.3 g (the proportion can be lower and higher) in 60 ml acetone and 40 ml distilled water, then impregnating an absorbent support material, e.g. filter paper or nonwoven fabric, with this solution over its entire surface or in strip or dot form, and then drying it. Tables 1 through 4 below indicate the color changes when various zinc salts and indicator dyes are used; the top line in each case indicates in boldface the quantity of zinc salt and two moisture levels. Indicated below in each case is the color for the first moisture content and the color for the second moisture content. It is evident that no color change occurs when the aforementioned indicator dyes are used without a zinc salt, whereas even with 1.15 g of zinc salt, a distinctly detectable color change occurs between a 40% and <8% moisture content.

An adsorbent, for example silica gel, can also be used instead of an absorbent support material.

### Color Changes

TABLE 1
Zinc chloride

| | no ZnCl₂ | 1.15 g ZnCl₂ | 3.3 g ZnCl₂ |
|---|---|---|---|
| Dye | 40%//<8% | 40%//<8% | 40%//<8% |
| Tropaeolin 00 | yellow// | yellow// | yellow//violet |
| | yellow | red-brown | |
| p-Xylenol blue | yellow// | yellow-orange// | yellow-orange//red-violet |
| | yellow | red | |
| Thymol blue | yellow// | orange// | red-orange//red-violet |
| | yellow | red-violet | |
| m-Cresol purple | yellow// | orange// | orange//deep red |
| | yellow | red | |

TABLE 2
Zinc nitrate tetrahydrate

| | no Zn (NO₃)₂ | 1.15 g Zn (NO₃)₂ | 3.3 g Zn (NO₃)₂ |
|---|---|---|---|
| Dye | 40%//<8% | 40%//<8% | 40%//<8% |
| Tropaeolin 00 | yellow// | yellow// | yellow//brown |
| | yellow | light brown | |
| p-Xylenol blue | yellow// | yellow-orange// | yellow-orange// |
| | yellow | red | red |
| Thymol blue | yellow// | orange// | red-orange// |
| | yellow | red | red-violet |
| m-Cresol purple | yellow// | yellow// | yellow//red |
| | yellow | red | |

TABLE 3
Zinc sulfate heptahydrate

| | no ZnSO₄ | 1.15 g ZnSO₄ | 3.3 g ZnSO₄ |
|---|---|---|---|
| Dye | 40%//<8% | 40%//<8% | 40%//<8% |
| Tropaeolin 00 | yellow// | yellow//yellow | yellow//yellow |
| | yellow | | |
| p-Xylenol blue | yellow// | yellow// | yellow//light red |
| | yellow | light red | |
| Thymol blue | yellow// | orange// | red-orange//light red |
| | yellow | light red | |
| m-Cresol purple | yellow// | orange// | orange//bright red |
| | yellow | bright red | |

TABLE 4
Zinc acetate dihydrate

| | no Zn (ac)₂ | 1.15 g Zn (ac)₂ | 3.3 g Zn (ac)₂ |
|---|---|---|---|
| Dye | 40%//<8% | 40%//<8% | 40%//<8% |
| Tropaeolin 00 | yellow//yellow | yellow//yellow | yellow//yellow |
| p-Xylenol blue | yellow//yellow | yellow// | yellow//light orange |
| | | light orange | |
| Thymol blue | yellow//yellow | yellow// | yellow//light red |
| | | light red | |
| m-Cresol | yellow//yellow | yellow// | yellow//light red |
| purple | | light red | |

1. A moisture indicator comprising a support that is equipped with a substance which contains a moisture-indicating medium that reversibly changes color as a function of moisture,
wherein the moisture-indicating medium is a pH indicator dye that is combined with a zinc salt.

2. The moisture indicator as defined in claim 1, wherein the indicator dye has a color change in the acid range.

3. The moisture indicator as defined in claim 1 or 2, wherein the indicator dye belongs to the group m-cresol purple, thymol blue, Tropaeolin 00, or p-xylenol blue.

4. The moisture indicator as defined in one of claims 1 through 3, wherein the zinc salt is zinc chloride, zinc nitrate, zinc sulfate, and/or zinc acetate.

5. The moisture indicator as defined in one of claims 1 through 4, wherein the indicator dye and zinc salt are present at a ratio by weight of at least 1:5.

6. The moisture indicator as defined in claim 5, wherein the indicator dye and zinc salt are present at a ratio by weight of at least 1:20.

7. The moisture indicator as defined in one of claims 1 through 6, wherein the support comprises an absorbent cellulose or an absorbent plastic, for example filter paper or nonwoven fabric, and/or an adsorbent, for example silica gel.
